(19) United States
(12) Patent Application Publication
(10) Pub. No.: US 2023/0181424 A1
(43) Pub. Date: Jun. 15, 2023

(54) DELIVERY DEVICE FOR UNITS OF AN ORAL DOSAGE FORM

(71) Applicant: OnDosis AB, Molndal (SE)

(72) Inventors: Mats Johansson, Hisngs Backa (SE); Lubomir Petkov Gradinarsky, Molnlycke (SE)

(21) Appl. No.: 17/925,510

(22) PCT Filed: May 14, 2021
(86) PCT No.: PCT/EP2021/062879

§ 371 Date: Nov. 15, 2022

(30) Foreign Application Priority Data
May 15, 2020 (GB) 2007254.2

(51) Int. Cl. A61J 7/00

(52) U.S. Cl. CPC A61J 7/0053

(57) ABSTRACT

An apparatus for dispensing a solid oral dosage form is provided that includes one or more channels, each configured to store a plurality of units of the solid oral dosage form and having an outlet for dispensing the units therefrom. The apparatus further includes a rotatable shaft and a nut located on the shaft and configured to translate upon rotation of the shaft. The apparatus further includes one or more tines configured to translate with the nut. Each of the tine extends into a respective channel and is configured to push the units of the solid oral dosage form along the length of the respective channel to the outlet. Rotation of the shaft about its axis causes the units of the solid oral dosage form to be dispensed from the outlets of the channel(s) due to the translation of the one or more tines within the respective channel.

This application is entitled to the benefit of, and incorporates by reference essential subject matter disclosed in PCT Application No. PCT/EP2021/062879 filed on May 14, 2021, which claims priority to GB Patent Appln. No. 2007254.2filed May 15, 2020, which are hereby incorporated by reference in their entireties.

### BACKGROUND OF THE INVENTION

### 1. Technical Field

The present disclosure relates generally to devices for dispensing at least one drug or medicament in the form of a solid oral dosage form and various aspects of such devices relating, for example, to the dispensing of at least one solid oral dosage form from the device, the operation and mechanics of such devices and also certain aspects of the control systems for such devices. The solid oral dosage form may be in the form of one or more pellets, microtablets or minitablets (e.g., as defined herein). The device may be configured for unit-based dosing (e.g., able to dispense a specific or predetermined number of the solid oral dosage form, e.g., pellets, microtablets or minitablets).

### 2. Background Information

Solid oral dosage form (“ODF”) medications can be manufactured in, e.g., a tablet or pellet form. A tablet or pellet could contain different substances where the main ingredient(s) is/are the active pharmaceutical ingredient (“API”). Drug pellets could be administered to patients as prefilled capsules or compressed in a tablet. Dispensing mechanisms for various ODF drugs are known, and can range from blister-pack type devices, wherein individual tablets can be retained within pockets and retained therein by the use of foil, to dispensing bottles. Various more complicated mechanisms are also known, in particular for other types of drug formulation, for example those in the form of small pellets, which may typically be less than 10% of a particular dosage per unit. The advantage of dispensing drugs in pellet form can be that the dose can be varied using the same dispensing device. Another advantage is that the pellets could be easy to swallow by patients having difficulty swallowing, who are currently crushing the tablets in order to swallow. Crushing or dividing of tablets is also used today by patients to get, e.g., half a dose from a prescribed drug, a process which is not recommended and can be avoided if a device can dispense different flexible amounts of pellets. Variable dosing of pellets allows for a more exact tuning of the dose than what may be achieved using larger dosage forms such as tablets or capsules. Furthermore, for modified release formulations, pellets are often more robust against food interactions than larger dosage forms such as tablets.

It is desired to improve the mechanism by which drugs in pellet form are dispensed, for example in case of pediatric medicine; antibiotics for easier swallowing, in case of geriatric medicine; chronic medication for easier swallowing, in the case of certain controlled substances such as stimulants for ADHD or pain medications such as opioids; for improved control over the dispensed dose or limit the risk for overdosing, or for medications that require titration at initiation or flexible adjustments as a result of disease variability or as a result of achieved outcomes, for example in case of immunosuppression after organ transplant, for psychiatric disorders such as depression or for neurological disorders such as epilepsy.

### SUMMARY

Herewith will be described various aspects and embodiments of a dispensing device that may be used in the present invention, and in relation to any of the aspects and embodiments of the invention described herein insofar as they are suitable therefor. As will be appreciated, all of the devices operate on similar principles.

The present invention relates to devices for dispensing at least one drug or medicament in the form of a solid oral dosage form. As described below, the oral dosage form may be in the form of pellets and/or microtablets and/or minitablets, each having a largest dimension (e.g., width or diameter) between about 0.3 mm and about 10 mm, optionally between about 0.5 mm and about 5 mm, optionally between about 1 mm and about 4 mm, optionally between about 1.5 mm and about 3.5 mm, or optionally between about 2 mm and about 3 mm. In various embodiments the largest dimension (e.g., width or diameter) of the solid oral dosage form may be greater than about 0.3 mm, for example greater than about 0.5 mm. Additionally, or alternatively the largest dimension (e.g., width or diameter) of the solid oral dosage form may be less than about 10 mm, for example less than about 5 mm.

In an aspect of the invention, there is provided an apparatus for dispensing at least one drug or medicament in the form of a solid oral dosage form. The apparatus comprises one or more channels, each configured to store a plurality of units of the solid oral dosage form and having an outlet for dispensing the units therefrom, as well as a shaft rotatable about an axis, and a nut located on the shaft and configured to translate along the axis upon rotation of the shaft. The apparatus further comprises one or more tines configured to translate with the nut, wherein each of the one or more tines extend into a respective one of the channels and are configured to push the units of the solid oral dosage form along the length of the respective channel to the outlet, such that rotation of the shaft about the axis in use causes the units of the solid oral dosage form to be dispensed from the outlets of the channel(s) due to the translation of the one or more tines within the respective channel.

The above device solves the problem of how to accurately and efficiently administer specific units of a solid oral dosage form. The use of tines has been found to be particularly beneficial for achieving these effects, especially tines that translate through the action of a rotating shaft, the translation of the tines being in the same direction as the movement of the oral dosage form through the channels.

The oral dosage form may be a unit dose and/or a solid oral dosage form. It is envisaged that the oral dosage form could in some cases comprise a hard, solid (or semi-solid, e.g., gelatin or cellulose) outer shell and a softer core, such as a gel or even a liquid core. The channels may comprise the solid oral dosage form.

A further aspect of the invention relates to a device comprising an apparatus as described above, and further comprising a control unit configured to operate the apparatus by rotating the shaft.

The device may comprise a collection region configured to receive and contain units of the solid oral dosage form that have been dispensed from the apparatus. This can provide a useful way of storing dispensed units of the oral dosage form for subsequent transport and distribution.

The device may comprise a detachable cap, wherein the collection region may form part of the detachable cap, such that the solid oral dosage form dispensed from the apparatus can be received within the cap and subsequently dispensed from the cap. Using a detachable cap is seen as a particularly convenient way of providing for subsequent transport and distribution of the oral dosage form.

The device may further comprise a cartridge that is detachable from the control unit, wherein the cartridge may comprise one or more of the plurality of channels, the shaft, the nut and the one or more tines. Using the combination of a control unit and cartridge beneficially separates the operating mechanism of the device (i.e., within the control unit) from the part of the device configured to store the solid oral dosage form (i.e., the cartridge).

The control unit and the cartridge may cooperate via one or more connection mechanisms, such that rotation of a first part on the control unit causes a corresponding rotation of the shaft so as to cause the units of the solid oral dosage form to be dispensed from the outlets of the channel(s). This provides a simple mechanical connection between the control unit and cartridge. For example the one or more connection mechanisms may comprise a first rotatable element on the control unit, and a second rotatable element on the cartridge, where the first and second elements engage with each other such that rotation of the first element causes a corresponding rotation of the second element. The first and second elements may comprise cogs having cooperating teeth, or male and female engaging elements.

The one or more tines may be configured to translate along the axis a predetermined amount upon rotation of the shaft, the predetermined amount corresponding to a dimension of the units of the solid oral dosage form. For example, the predetermined amount may correspond to a translation that is roughly equivalent to a diameter of each unit of the solid oral dosage form. This can provide an increase in control of how the oral dosage form is dispensed. The control unit may be configured to rotate the shaft by the predetermined amount.

In various embodiments, the apparatus may be configured to dispense units of the solid oral dosage form one-by-one or sequentially. For example, a contact surface of each tine with the oral dosage form may be positioned at different axial locations (e.g., as described below and elsewhere herein), such that each tine is configured to dispense a unit of the solid oral dosage form from a respective channel one-by-one, and/or in a sequential manner. The control unit may be configured to rotate the shaft by a predetermined amount that causes only one unit to be dispensed during a single continuous rotation of the shaft. This means that an exact number of units of the solid oral dosage form can be dispensed from the device.

The apparatus may be configured to provide a dose comprising a specific number of units of the oral dosage form. For example, the control unit may be configured to rotate the shaft by a predetermined amount that causes a specific or predetermined number of units to be dispensed during a single continuous rotation of the shaft. This means that a number of units of the solid oral dosage form can be dispensed from the device to provide a dose, the dose consisting of a specific number of units of the oral dosage form.

The apparatus may further comprise a plurality of tines, each comprising a surface that is configured to contact and push units of the solid oral dosage form along the length of the respective channel to the outlet.

The contact surface of a first of the plurality of tines may be located at a different axial position than the contact surface of a second of the plurality of tines. This provides that units of the solid oral dosage form can be dispensed one-by-one or sequentially.

The plurality of tines may comprise a first group of tines and second, different group of tines, wherein the contact surfaces of the first group of tines may all be located at substantially the same first axial position and the contact surfaces of the second group of tines may all be located at substantially the same second axial position, wherein the first and second axial positions are different. This provides that a predetermined number of units of the solid oral dosage form can be dispensed at the same time, and optionally sequentially, for example the number of units dispensed at the same time may correspond to the number of tines within each of the first and second groups.

The contact surfaces of the first and second groups of tines may be configured so that a predetermined number of units of the solid oral dosage form are dispensed at substantially the same time by the first and second groups of tines. The predetermined number of units may correspond to a particular dose of the oral dosage form, such that the first group of tines may dispense a first dose and the second group of tines may dispense a second (e.g., different) dose. In some embodiments the first group of tines may dispense the same dose as the second group of tines (i.e., the same number of units), wherein the dosages corresponding to the first and second groups of tines are dispensed sequentially.

The control unit may be configured to rotate the shaft in first and second continuous (but separate) rotations, wherein the first continuous rotation causes the first group of tines to dispense units of the oral dosage form at a first time, and the second continuous rotation causes the second group of tines to dispense units of the oral dosage form at a second, different time. This means that a number of units of the solid oral dosage form can be dispensed from each of the first and second groups of tines to provide separate dosages, wherein each dose consists of a specific number of units of the oral dosage form.

The tines may be spaced circumferentially around a perimeter of the nut, and the contact surface of each of the plurality of tines may vary depending on the circumferential position of the respective tine. For example, the contact surface of each of the plurality of tines may vary progressively from one tine to the next in a circumferential direction. In this manner the contact surfaces may be configured such that the plurality of tines dispenses units of the solid oral dosage form sequentially.

The control unit may be configured to rotate the shaft by a predetermined amount that causes units of the oral dosage form to be dispensed sequentially from one tine to the next in a circumferential direction. For example, the control unit may be configured to rotate the shaft in a first (single) continuous rotation to cause a first (single) unit to be dispensed from a first channel, and then subsequently rotate the shaft in a second (single) continuous rotation to cause a second (single) unit to be dispensed from a second, adjacent channel, and continue by rotating the shaft in successive (single) continuous rotations to cause a successive (single) units to be dispensed from a successive adjacent channels.

The apparatus may further comprise a plurality of units of the solid oral dosage form within the channel(s), wherein a diameter of the channel(s) is sufficient for the units of the solid oral dosage form to move within the channel(s) without a frictional contact with any surface of the channel(s). For example, a diameter of the channel(s) may be greater than a diameter of the units of the solid oral dosage form. The diameter of the channel(s) may be at most (or equal to) about 1.05, 1.1, 1.15, 1.2 or even 1.25 times a diameter of the units of the solid oral dosage form. The diameter of the channel(s) may be between about 1.05 and about 1.1, 1.15, 1.2 or 1.25 times a diameter of the units of the solid oral dosage form, for example between about 1.05 and 1.2 times a diameter of the units of the solid oral dosage form. These ratios are chosen to provide sufficient space in the channel(s) around the units of solid oral dosage form to allow them to travel freely down the channel(s), without allowing the units of solid oral dosage form to rotate to an incorrect position and/or inadvertently fit through one of the axially extending slots for the plunger tines (see, e.g., 222 and 232 described below).

The device may further comprise a device configured to prevent the solid oral dosage form from falling out of the channels unintentionally or when the shaft is not being rotated. The device configured to prevent the solid oral dosage form from falling out of the channels may comprise one or more blocking members or components (e.g., that may be movable). The blocking member or component may be configured in a first position to block an exit of the solid oral dosage form from each of the channels, and in a second, different position to allow the solid oral dosage form to exit the channels. The blocking member or component may be configured such that in a resting position, and/or when the shaft is not being rotated, the blocking member or component occupies its first position.

In accordance with an aspect of the invention there is provided a method of operating a device or apparatus as described above.

The method may comprise storing a plurality of units of the solid oral dosage form within the channel(s), and rotating the shaft about its axis so as to cause translation of the one or more tines and the units of the solid oral dosage form to be dispensed from the outlets of the channel(s).

The method may comprise method steps corresponding to any of the functional features described above, for example in respect of the control unit being configured to provide a certain function. The control unit may comprise a processor or circuitry configured to carry out any of the functional features described.

The device may be a hand-held and/or portable device. In other words, the device may be held and transported using one hand and/or operable using one hand. For example, the device (e.g., the entire device or the cartridge) may have a length (corresponding to its longest dimension) of no more than about 250 mm (such as less than about 200 mm, about 150 mm or about 100 mm), and a width or height (i.e., transverse to its length) of no more than about 50 mm, and optionally no more than about 40 mm (and in some embodiments less than 30 mm or even less than 20 mm). In order to optimize its hand-held nature, the device may have a length between about 180 mm and about 220 mm, a width (transverse to its length) between about 35 mm and about 45 mm, and a height (transverse to its width) of between about 22 mm and about 32 mm. The device (or cartridge) may weigh no more than about 500 g, about 400 g, about 300 g, about 200 g, or even about 100 g. This can ensure that the device is light enough to carry in one hand.

The cartridge (or cartridges) may have a length (corresponding to its longest dimension) of between about 90 mm and about 120 mm, a width (transverse to its length) between about 33 mm and about 43 mm, and a height (transverse to its width) of between about 15 mm and about 25 mm.

Further technical effects will become apparent from the description provided below.

### DEFINITIONS

Pellet, microtablet, minitablet - A single oral dosage form unit of a medicament, drug, medication or the like, each having a largest dimension (e.g., width or diameter) between about 0.5 mm and about 5 mm, optionally between about 1 mm and about 4 mm, between about 1.5 mm and about 3.5 mm, between about 2 mm and about 3 mm. In various embodiments the largest dimension (e.g., width or diameter) of each unit of the solid oral dosage form may be greater than about 1 mm, which has been found to prevent clogging of the channels of the device. Additionally, or alternatively the largest dimension (e.g., width or diameter) of the each unit of the solid oral dosage form may be less than 5 mm. By “diameter” it is meant that each unit of the solid oral dosage form (e.g., pellet, microtablet, minitablet) may be assumed to be roughly spherical or cylindrical, although they could be irregular shaped. The diameter could correspond to a largest width of each unit of the solid oral dosage form (e.g., pellet, microtablet, minitablet), if they are not assumed to be spherical. The solid oral dosage form (e.g., pellet, microtablet, minitablet) may or may not have a surface coating.

Dose - A single measurement, such as a specific number) of solid oral dosage form unit(s) (e.g., pellet(s), microtablet(s) or minitablet(s)). The number of units may correspond to a specific amount (weight) of active pharmaceutical ingredient (“API”). The number may be any integer less than, e.g., 20. In some cases the dose may be between 1 and 20 units of the solid oral dosage form, for example between 1 and 10, or even 1 and 5 units of the solid oral dosage form.

Dispensing Mechanism - A system, e.g., an electromechanical system that converts a user’s action into the dispensing of a specific dose, e.g., a specific number of solid oral dosage form units as described above, e.g., pellets, microtablets or minitablets.

Cartridge - A component, e.g., a replaceable component used to store and dispense the solid oral dosage form.

Dispensing Aperture - The open end of the cartridge that allows the solid oral dosage form to be dispensed for consumption.

Cap - A container or tray that covers the dispensing aperture, for collection of a dose and for protection of the stored oral dosage form from humidity.

Press - An action performed by a user on the device when they wish to dispense their specified dosage, this could be rotary or linear motion.

It will be appreciated that a reference to “a” drug or medicament as referred to herein may be taken as “one or more” drugs or medicaments. For example, the solid oral dosage form could comprise several drugs or medicaments, for example in pellet form. This could be achieved by mixing different solid oral dosage forms, each comprising a different drug or medicament, and/or mixing drugs or medicaments within each solid oral dosage form. As discussed in more detail below, it may be possible to administer different types of drug or medicament (including, e.g., a placebo). This provides the possibility to have one or more drugs in the same device (which would typically require different dosing), and this can be achieved in different ways. For example, a gear mechanism may be used in connection with the nut and tines, such that different ones of the tines can be moved at different speeds.

### BRIEF DESCRIPTION OF THE DRAWINGS

Various embodiments will now be described, by way of example only, and with reference to the accompanying drawings in which:

FIG. 1 shows a perspective view of a device according to various aspects and embodiments of the invention that is capable of dispensing at least one drug or medicament in the form of a solid oral dosage form;

FIG. 2 shows the device of FIG. 1 with a cartridge broken away from a control unit thereof, and schematically showing internal features of the device;

FIG. 3 shows the device of FIG. 1 with the cartridge attached to the control unit, and schematically showing internal features of the device;

FIG. 4 shows a blocking member of the device of FIG. 1 in isolation;

FIG. 5 shows a plunger of the device of FIG. 1 in isolation;

FIGS. 6 and 7 show different embodiments of a plunger and blocking member that may be used with the device of FIG. 1;

FIG. 7A shows an embodiment of a blocking component that may be used instead of, or in combination with the blocking member;

FIGS. 8 and 9 show an embodiment of a plunger and a chassis that may be used with the device of FIG. 1;

FIGS. 10 and 11 schematically show the operation of the device of FIG. 1;

FIG. 12 illustrates an embodiment of the device of FIG. 1 in which a plunger is configured with a plurality of tines, each having a contact surface occupying a different axial position;

FIG. 13 schematically shows a shaft and plunger of the device of FIG. 1 in isolation;

FIG. 14 shows a dispensing mechanism of the device of FIG. 1 in isolation, comprising a shaft, plunger and chassis having channels; and

FIGS. 15 and 16 show an embodiment of a cartridge that comprises two of the apparatus shown in FIG. 14.

### DETAILED DESCRIPTION

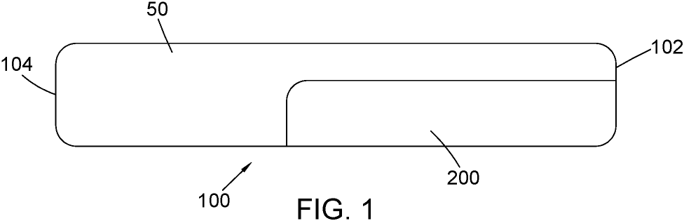

FIG. 1 shows a perspective view of a device 100 according to various aspects and embodiments of the invention, and is a device capable of dispensing at least one drug or medicament in the form of a solid oral dosage form.

The device 100 has the aim of making the dispensing of repeat prescriptions simpler and more convenient than e.g., existing blister pack medications, and would enable changing the administered dose in a straight-forward way if desired for a certain treatment (e.g. for medications that would benefit from titrations or flexible adjustments). The device 100 also aims to deliver reliable doses of medications of the oral dosage form (e.g., in pellet form), and in particular enables the dispensing of a specific number of units of the oral dosage form.

The following description will refer to pellets as comprising the oral dosage form, but it will be appreciated that this is simply for brevity and any type of solid oral dosage form may be interchanged, such as microtablets or minitablets.

FIG. 1 shows the device 100 in an assembled state, which comprises a first end 102 and a second end 104. The first end 102 typically comprises the dispensing end of the device 100, out of which one or more pellets may be dispensed.

The device 100 may comprise one or more cartridges 200 (a single cartridge 200 is shown in the embodiment of FIG. 1) that are configured to control the movement and dispensing of the pellets within the device 100 prior to being dispensed therefrom.

The device 100 may further comprise a control unit 50 that may be configured to house various electronic and mechanical components, and is configured to control the dispensing of the pellets from the cartridge 200. For example, the control unit 50 typically comprises a controller (e.g., a computer, processor or circuitry) configured to actuate one or more dispensing mechanisms of the cartridge 200 so as to move the pellets within the cartridge 200 and ultimately dispense them from the device 100. The control unit 50 may comprise one or more motors and/or actuators for this purpose.

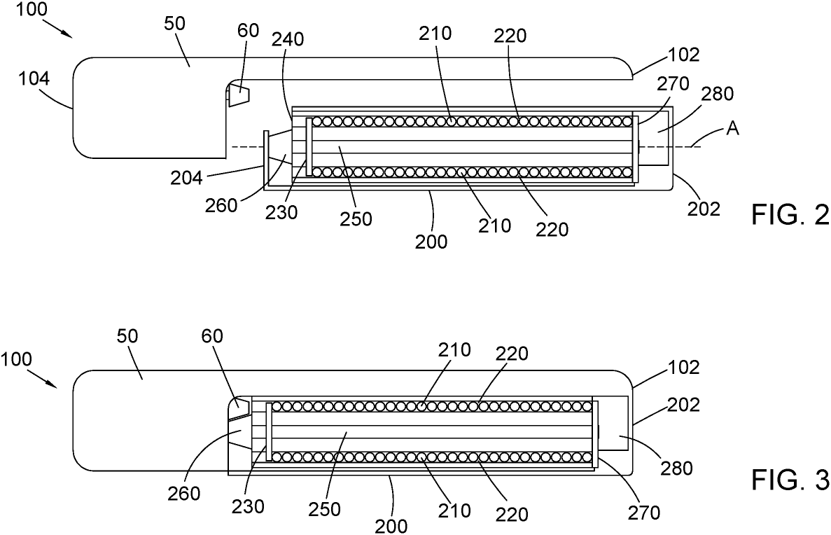

FIG. 2 shows the device 100 with the cartridge 200 broken away from the control unit 50, and wherein various internal features of the cartridge 200 are shown schematically. The cartridge 200 comprises a first end 202 and a second, opposite end 204, wherein the first end 202 of the cartridge 200 corresponds to the dispensing end of the cartridge 200.

The cartridge 200 may be a self-contained and portable unit and is configured to house a number of pellets 210. The cartridge 200 comprises one or more channels 220 into which the pellets 210 are inserted. The channels 220 may be sized so that they hold the pellets 210 sequentially, or one after the other. In other words, the pellets 210 may not be able to move past each other within the channels 220. The channels 220 may form part of a chassis 240 that is received within the cartridge 200.

The cartridge 200 may comprise a movable baffle or plunger 230 that is configured to translate within the cartridge 200 and push pellets 210 through their respective channels 220 towards the first end 102 of the device 100, and ultimately dispense them from the cartridge 200. In various embodiments the plunger 230 does not substantially rotate as it translates within the cartridge 200. By “substantially” in this regard, it is meant that very small rotations of the plunger 230 may occur due to, e.g., manufacturing tolerances, but the plunger 230 is intended not to rotate as it moves within the cartridge 200.

The cartridge 200 may comprise a rotating member or shaft 250 that is configured to cooperate with the plunger 230 so that rotation of the shaft 250 about its longitudinal axis A causes translation of the plunger 230 along the axis A so as to push pellets 210 through their respective channels 220 and dispense them from the cartridge 200 as aforesaid. For this purpose, the plunger 230 may comprise a screw thread that cooperates with a screw thread 252 (see FIG. 11) on the shaft 250 such that the plunger 230 acts like a nut cooperating with the screw thread 252 on the shaft 250.

The cartridge 200 further comprises one or more connection elements 260 that are operably connected to the shaft 250 such that rotation of the connection elements 260 causes a corresponding rotation of the shaft 250.

The control unit 50 may comprise connection element 60 configured to cooperate with the connection elements 260 on the cartridge 200, such that rotation of the connection elements 60 on the control unit 50 cause a corresponding rotation of the connection elements 260 on the cartridge. For example, the connection elements 60, 160 on the control unit 50 and cartridge 200 respectively may be cooperating gears configured to rotate and cause a corresponding rotation of the shaft 250. Other actuating mechanisms may be used, for example the connection elements 60, 160 may comprise male and female connection elements, such as a plug and socket type arrangement.

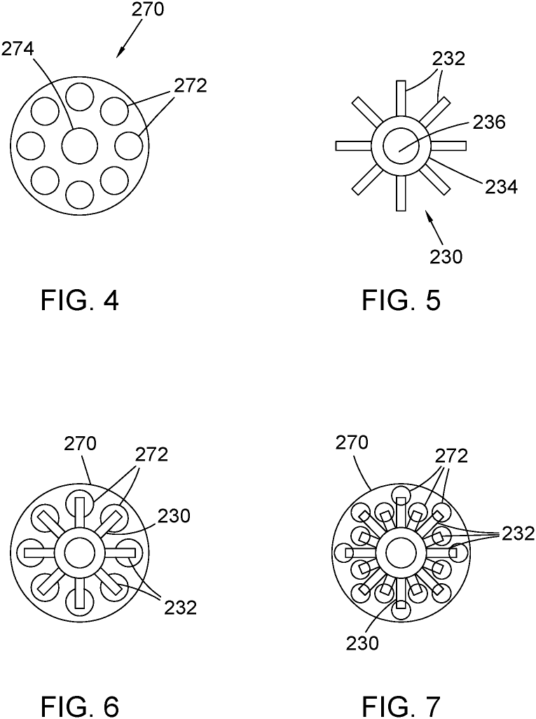

The cartridge 200 may comprise a blocking or restriction member 270, or other device that is configured to prevent pellets 210 from falling out of the channels 220 unintentionally, for example when the shaft 250 is not being rotated. The blocking member 270 may be in the form of a plate, e.g. an elastomeric plate having apertures 272 (see FIG. 4) that are slightly smaller than the diameter of the pellets, but sized so that the pellets can be pushed through the apertures in use by the action of the plunger 230.

The cartridge 200 comprises a collection region 280 into which the pellets 210 are configured to fall as they are dispensed from the channels 220 past the blocking member 270. The collection region 280 acts to control the dispensing and subsequent handling of the pellets 210 with greater ease. A further function of the collection region 280 is to contain the pellets as they are expelled from the channels 220. For example, upon exiting the channels 220 the pellets may have a large amount of energy (e.g., the method of dispensing may input a large amount of kinetic energy to the pellets) and so the pellets may be liable to, e.g., bounce off opposing surfaces of the cartridge 200.

FIG. 4 shows the blocking member 270 from a different orientation, so that the apertures 272 of the blocking member 270 can be seen, through which pellets 210 may pass in use. The blocking member 270 further comprises a central aperture 274 through which the shaft 250 may pass. However, it will be appreciated that the blocking member 270 does not rotate with the shaft 250 in use, so that the apertures 270 stay in proper alignment. For example, the blocking member 270 may be fixed against rotation using one or more splines or other type of member that engages with a non-rotating portion of the device 100 to prevent rotation of the blocking member 270. The shaft 250 may be free to rotate within the central aperture 274, or may have a minimal amount of contact with the central aperture 274 that permits rotation of the shaft 250.

FIG. 5 shows the plunger 230 also from the same orientation as the blocking member 270 in FIG. 4. The plunger 230 may comprise a plurality of tines 232 that extend from a central, cylindrical portion 234 configured to mate with the shaft 250. The plunger 230 comprises a central aperture 236 that may comprise a screw thread configured to mate with the screw thread 252 on the shaft 250, so that the plunger 230 translates along the axis of the shaft 250 upon rotation thereof as aforesaid. As will become apparent, the tines 232 each extend into a respective channel 220 of the chassis 240 so as to push or move along the pellets 210 in use as the plunger 230 translates in this manner.

FIG. 6 shows the plunger 230 and blocking member 270 when they are aligned with each other in use. As can be seen, each tine 232 is aligned with a respective aperture 272 of the blocking member 270. As the plunger 230 moves in use, each tine 232 moves within a respective channel 220 of the chassis 240, and towards a respective one of the apertures 272. This means that pellets 210 contained within the channels 220 are pushed through and out of the apertures 272 by the action of the tines 232 of the plunger 230. The tines 232 may remain aligned with a respective aperture 272 throughout the entire range of movement of the plunger 230.

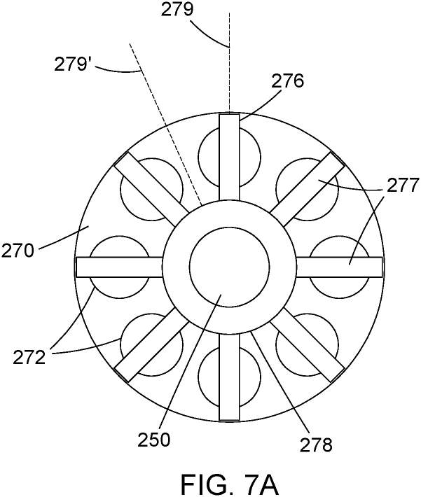

Any suitable number of tines 232 and apertures 272 may be chosen depending on the application at hand. For example, FIG. 7 shows a blocking member 270 having sixteen apertures 272, as well as a plunger 230 having an equal number of tines 232, each corresponding to a respective aperture 272.

In various embodiments the cartridge 200 may (e.g., in addition to the blocking member 270) comprise a blocking component 276 configured to block the exit of the pellets 210 from the channels 220 and (if provided) the blocking member 270.

As shown in FIG. 7A, the blocking component 276 could be similar to the plunger 230, and may comprise a plurality of tines 277 that extend from a central, cylindrical portion 278. However, in contrast to the plunger 230 the blocking component 276 may remain at substantially the same axial position, for example at the end of the channels 220, abutting the blocking member 270 or immediately adjacent thereto. The blocking component 276 may initially be configured such that the tines thereof block the channels 220 and (if provided) apertures 272 and prevent pellets from being dispensed therefrom.

Upon rotation of the shaft 250 to dispense pellets, the blocking component 276 may be configured such that the tines thereof move slightly to a position in which they do not block the channels 220 and/or apertures 270, and allow pellets to be dispensed from the cartridge 200. This may be caused by a suitable connection (e.g., spline connection) between the blocking component 276 and the shaft 250, which is configured such that an initial small rotation of the shaft 250 causes the blocking component 276 to move (e.g., rotate and/or bend) slightly so that the tines thereof fall out of alignment with the apertures 270. The blocking component 276 may not continue to rotate with the shaft 250, e.g., the blocking component 276 may stop rotating shortly after the initial rotation of the shaft 250, so that further rotation of the shaft 250 does not cause the blocking component 276 to continue rotating and move the tines 277 thereof back into alignment with the apertures 270.

The cartridge 200 may comprise one or more stops that are configured to prevent the blocking component 276 from rotating further once the tines thereof move out of alignment with the channels 220 and/or apertures 270. For example, one or more flanges may extend into the path of the blocking member 270 so that at least one of the tines 277 abuts a flange. The blocking component 276 may be in friction-type connection with the shaft 250 such that as the shaft 250 starts to rotate, the friction between the shaft 250 and the blocking component 276 induces the blocking component 276 to rotate, until the blocking component 276 abuts against the one or more stops. A biasing member, for example a resilient member (e.g., spring), may be configured to urge the blocking component 276 back to its original, resting position in which the tines 277 are blocking the channels 220 and/or apertures 270. Alternatively or additionally, a dedicated motor may drive the blocking component 276 to cause it to rotate slightly to and from the blocking position (in which the tines 277 block the channels 220 and/or apertures 270).

FIG. 7A indicates an initial position of the blocking member 276, wherein the tines 277 thereof are positioned in line with, e.g., dotted line 279. After the initial small rotation the blocking member 276 may move to the position indicated at dotted line 279′. Thus, it can be appreciated that the tines 277 would have moved out of alignment with the apertures 270 to allow pellets to be dispensed from the cartridge 200.

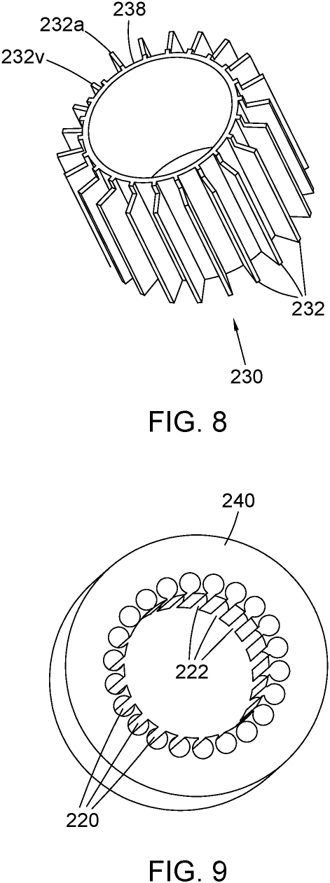

FIG. 8 shows an embodiment of a plunger 230 having twenty-two tines 232. The plunger 230 of FIG. 8 is configured to operate in the same manner as the plunger 230 described above, namely to take the form of a nut that travels along the screw thread 252 of the shaft 250. The tines 232 of the plunger 230 in this embodiment take the form of elongated plates, as opposed to, e.g., pins, wherein the plates extend axially along the length of the plunger 230 by differing amounts. For example, the tine shown at 232a sits substantially flush with a forward end 238 of the plunger 230, whereas the tine shown at 232v has a cutout, such that it is set back from the forward end 238. This is to enable the plunger 230 to dispense pellets one at a time from each of the channels 220, and the exact mechanism for this will be described in more detail below.

FIG. 9 shows an axial section of one embodiment of a chassis 240 that is configured to cooperate with the plunger 230 shown in FIG. 8. The chassis 240 comprises a plurality of channels 220 configured to hold pellets 210 in use. Each of the channels 220 comprises an axially extending slot 222 through which a respective tine 232 of the plunger 230 may extend, so that each tine 232 extends through a respective slot 222 into a respective one of the channels 220. The tines 232 may be slidably received within the slots 222 and/or channels 220.

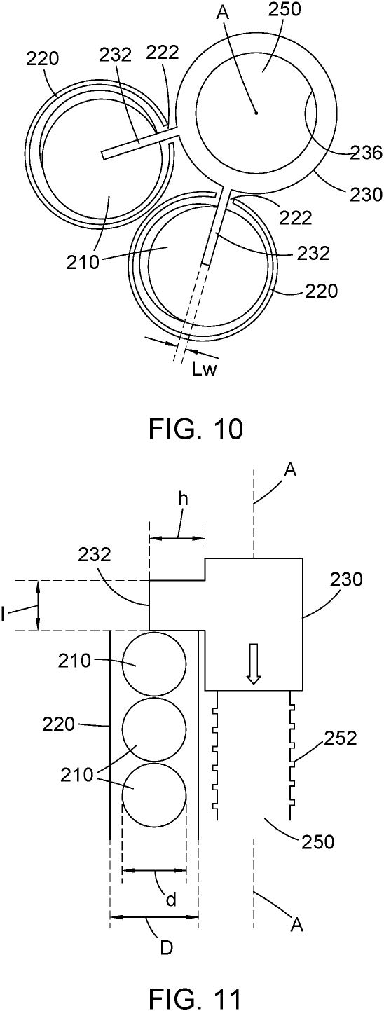

FIGS. 10 and 11 show schematically the operation of the mechanism described above in various aspects and embodiments.

The shaft 250 is shown as extending through the central aperture 236 of the plunger 230, wherein a screw thread 252 on an outer cylindrical surface of the shaft 250 cooperates with a screw thread on an inner cylindrical surface forming the central aperture 236, such that rotation of the shaft 250 causes movement (e.g., translation) of the plunger 230 along the axis A. As can be seen in FIG. 10, the tines 232 (only two of which are shown for brevity) each extend through a respective slot 222 and into a respective channel 220 as discussed above. In the illustrated embodiment, the tines 232 extend into each channel 220 roughly by a distance corresponding to half of the diameter of the channel 220. However, any suitable size of the tines 232 may be used that satisfy the functional requirements of moving the pellets 210 as described herein.

The size of the pellets 210 may be slightly smaller than a diameter of the channels 220, as shown for example in FIG. 10. As such, the pellets 210 may not be able to move past one another as they are lined up within the channels 220.

As the plunger 230 moves (e.g., translates) along the axis A the tines 232 also move or translate through the channels 220. The slots 222 are provided so as to permit the tines 232 to move axially in this manner. The slots 222 are large enough to permit the tines 232 to translate freely as they move through the channels 220, but small enough to prevent any pellets 210 from leaving the channels 220 via the slots 222. As shown in FIG. 10, a width of the slots 222 may be much smaller than a diameter of the pellets 210, for example a width of the slots 222 may be at least 5, 6, 7, 8, 9 or even 10 times smaller than a diameter of the pellets 210.

FIG. 11 shows pellets 210 stacked within a respective channel 220 as described above. The pellets 210 may be stored in or filled into the channels 220 such that they stack on top of each other, as shown schematically in FIG. 11. A diameter D of the channels 220 may be chosen so that the pellets 210 can move within the channel 220 with limited friction and without getting stuck or blocking each other. For example, the diameter D of the channels 220 may be greater than a diameter of the pellets 210, for example greater than (or equal to) about 1.05, 1.1, 1.15, 1.2 or even 1.25 times a diameter d of the pellets 210. As discussed elsewhere herein the pellets 210 can be spherical or other shapes, and in the latter case the diameter d may correspond to a largest dimension or width of the pellets 210 (or, broadly, solid oral dosage form).

Each tine 232 of the plunger 230 may extend in the axial direction by a given dimension, shown in FIG. 11 as a length 1. In various embodiments each tine 232 of the plunger 230 may have a different length 1 depending on its circumferential position on the plunger 230. For completeness, FIG. 11 also shows a height h of the tine 232, whilst FIG. 10 shows the width w. The length 1 of each tine 232 may be tailored based on the design of the plunger 230.

In various embodiments, the length of the tines 232 varies based on the diameter of the pellets 210 and the number of channels 220. For example, if the diameter of the pellets 210 is 1 mm, and the number of channels is ten, then the screw thread 252 of the shaft 250 and the plunger 230 could be configured so that one turn of the shaft 250 (e.g., 360 degrees) moves the plunger 230 by 1 mm. Such an arrangement would cause the tines 232 to push exactly ten pellets 210 out of the end of the channels 220 upon one rotation of the shaft 250 (e.g., 360 degrees). The technical effect of such an arrangement is that a particular rotation of the shaft 250 causes a specific number of pellets 210 to be pushed out of the channels 220 and dispensed from the device 100. In this manner the device 100 can control the number of pellets 210 that are dispensed from the channels 220 by tailoring the shaft 250 (e.g., screw thread 252) and plunger 230, as well as the tines 232, channels 220 and pellets 210.

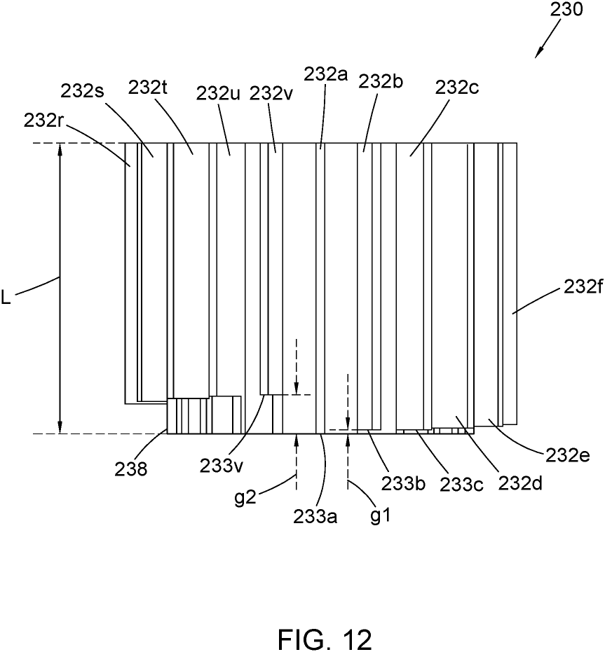

FIG. 12 illustrates this concept for the plunger 230 shown in FIG. 8, in that a first tine 232a sits substantially flush with an axial reference point (in this case a rim 238) located on the plunger 230. It will be appreciated that the reference point may not be the rim 238, and could be the portion of the plunger 230 corresponding to the axial position of an axially forward edge 233a of the first tine 232a. The second tine 232b has a slightly shorter length, such that an axial gap g1 exists between an axially forward edge 233b of the second tine 232b and the axial reference point 238. The third tine 232c has a slightly shorter length than the second tine 232b, such that a slightly larger axial gap exists between an axially forward edge 233c of the third tine 233c and the axial reference point 238. This continues for each of the further tines 232d-v, which have progressively shorter lengths, such that progressively larger axial gaps are present between respective axially forward edges of each tine 232d-v and the axial reference point 238. Finally, the tine 232v circumferentially adjacent to the first tine 233a (with no other tines in between) has an axial gap g2 between an axially forward edge 233v thereof and the reference point 238 that is the largest of the axial gaps.

In operation, the plunger 230 shown in FIG. 12 will operate as described above, such that the plunger 236 is located around the shaft 250 and translates in an axial direction. Each of the tines 232a-v extends into a respective channel 220 through a respective slot 222. The first tine 232a will cause a first pellet 210 to exit from the channels 220, since its forward edge 233a is located axially forward of the forward edges of the remaining tines 232b-v. Then, the second tine 232b will cause a second pellet 210 to exit from the channels 220 (after the first pellet), since its forward edge 233b is located axially forward of the forward edges of the remaining tines 232c-v. This process will continue until the final tine 232v that is circumferentially adjacent to the first tine 233a causes a pellet 210 to exit from the channels 220, at which point the first time 232a will cause the next pellet 210 to exit from the channels 220 and the process repeats.

It will be appreciated that the tines 232 do not have to vary in length progressively in the circumferential direction, but could have lengths that vary in a non-linear or non-progressive manner. Alternatively, groups of the tines 232 could have the different lengths, such that a first group has a first length and a second group has a second length, or any other suitable arrangement of groups. This could beneficially provide for a specific number of pellets being dispensed by each group, in that if the first group was comprised of four tines then four pellets would be dispensed by that group substantially at the same time. It will be appreciated that any number of arrangements could be provided, wherein the device could be configured so that specific numbers of pellets 210 could be dispensed based on a certain rotation of the shaft 250.

It will also be appreciated that the tines 232 may not vary in length to achieve the above effects. They may have the same length (or any length), wherein the axially forward surface of each of the tines is located at a different position along the longitudinal axis A, wherein the axially forward surface corresponds to the surface that contacts and pushes the pellets towards the dispensing end of the device 100 in use.

The above embodiments contribute to various technical effects of the invention described herein, in that one of the aims of the devices described herein is to improve unit-based dosing, and this is achieved in these embodiments by having tines of varying length. It should be noted that even the broadest aspects of the disclosure, which may include tines of equal length, still achieve such technical effects. However, using tines of varying length creates more possibilities and enables the device to be tailored to more specific requirements.

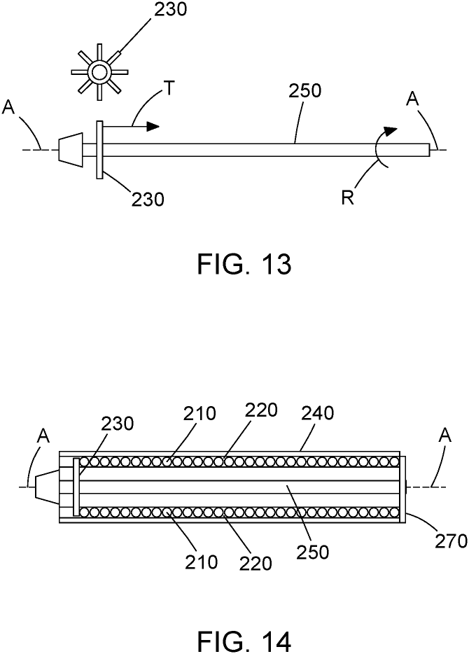

FIG. 13 shows schematically the shaft 250 and plunger 230 in isolation. As will be appreciated from the description above, as the shaft is rotated (as indicated by the arrow R) the plunger 230 translates axially along the shaft (as indicated by the arrow T). Throughout this translation the plunger 230 does not substantially rotate, other than the very small rotation permitted due to the movement of the tines 232 within the slot 222.

FIG. 14 shows the dispensing mechanism, namely shaft 250, plunger 230 and chassis 240 having channels 220, with (optionally) pellets 210 and blocking member 270 in isolation. These features may form part of an apparatus that may be claimed independently, since it is considered that such features achieve the various technical effects set out herein. Further technical effects will become apparent, however, when combining such features with the remaining features of the device 100.

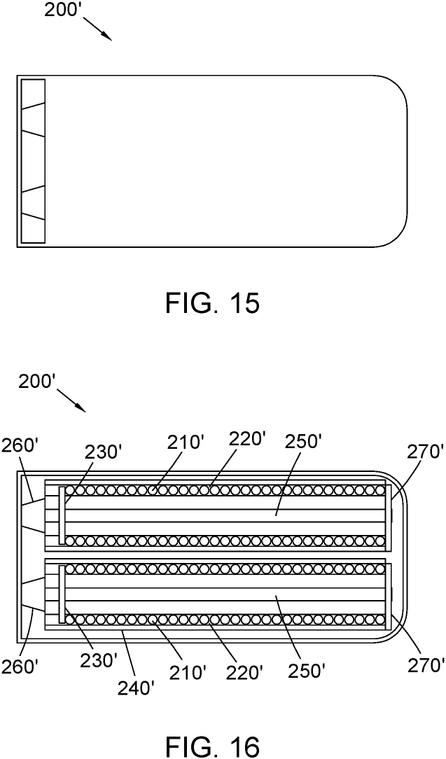

FIGS. 15 and 16 show an embodiment of a cartridge 200′ that comprises two of the apparatus shown in FIG. 14. The reference numerals in this embodiment indicate similar features as those of the previous embodiments, but with an apostrophe following the numeral. The cartridge 200′ of this embodiment could be integrated into a control unit that comprises two connection elements each configured to cooperate with a respective connection element 260′ on the cartridge 200′, such that rotation of each connection element on the control unit causes a corresponding rotation of the connection elements 260′ on the cartridge. The connection elements of the control unit may be substantially the same as those described above in respect of the control unit 50 shown in FIGS. 2 and 3. That is, the connection elements on the control unit and cartridge 200′ respectively may cooperate so as to rotate and cause a corresponding rotation of a respective shaft 250′.

The devices described herein may be configured to dispense or provide a specific number of units according to, e.g., a prescribed dosage. The devices described herein are particularly suitable for pellet type dosage forms in which the pellets are of the millimeter scale according to the definition provided above. The devices may consist of two main parts, namely the control unit and cartridge, wherein the cartridge may comprise one or more dispensing mechanisms as shown in FIG. 14. The control unit may comprise a battery, actuator (e.g., motor), and electronics for controlling the actuator. The cartridge may be prefilled with the desired oral dosage form, e.g., pellets, and may be refillable with the desired oral dosage form. The cartridge may be removable from the control unit, and the dispensing mechanisms as shown in FIG. 14 may be removable from the cartridge so as to refill the chambers therein with the desired oral dosage form.

The dispensing mechanism may be configured to provide a dose comprising a specific number of units of the oral dosage form, e.g., pellets. Generally the device is configured to provide a controlled and secure delivery of a desired dosage. The design of the device builds on a principle of pushing the oral dosage form, e.g., pellets through respective channels using a plunger, based on the action of a rotating member or shaft, the rotation of which is controlled by the control unit. In various embodiments a given rotation of the shaft will cause a specific number of pellets to be dispensed from the dispensing mechanism. As described above this may be achieved using tines of a specific length, wherein in various embodiments the tines may have different lengths corresponding to the desired amount of dosage. In various embodiments the device may be configured to dispense a single pellet, i.e., one by one.

In various embodiments a gear mechanism could be provided between the nut and different ones of the tines, such that the tines moved at different rates upon translation of the nut. As noted above this allows the same device to be used for administering different types of oral dosage form in each chamber, and can be achieved in different ways. For, example as noted a gear mechanism could be provided between the nut and different ones of the tines. This could utilize, for example, gear wheels with different diameters (similar to a gear box), or each having a different pitch of screw thread, wherein each gear wheel is associated with (e.g., connected to) a respective tine.

In various embodiments the device may be configured such that the oral dosage form is dispensed from the dispensing mechanism into a collection region, cup or cover of the cartridge, at which point the desired dose, i.e., the specific number of pellets dispensed from the dispensing mechanism, may be accessed by a user. The collection region may form a substantially closed cavity when the cartridge is connected to the control unit, which prevents the pellets from falling out thereof or from the device. In order to access the collection region, a user may be required to expose the collection region by sliding the cartridge relative to the control unit, or simply removing the cartridge from the control unit. Alternatively, the collection region could comprise a movable member configured to cover an access port to the collection region, so that in use a user could move the movable member to expose the access port and the collection region.

In various embodiments the collection region could form part of a removable or detachable cap or cover, wherein the removable or detachable cap or cover connects to the cartridge by a snap fit mechanism, or other suitable type of mechanism that enables the cap or cover (comprising the collection region) to detach and then reattach to the cartridge.

The control unit may be configured to rotate the shaft of the dispensing mechanism a specific or predetermined amount that corresponds to a specific or predetermined number of units (e.g., pellets) of the oral dosage form. This enables the device to be able to dispense a specific number of units, e.g., into the collection region. For example, a user could request a desired number of units or dosage (e.g., using an input device of the control unit), and the control unit could be configured to then rotate the shaft of the dispensing mechanism the required amount to dispense the desired number of units, or a specific number of units corresponding to the desired dosage, into the collection region.

Although the present invention has been described with reference to exemplary or preferred embodiments, it will be understood by those skilled in the art that various changes in form and detail may be made without departing from the scope of the invention as set forth in the accompanying claims.

For example, it will be appreciated that there is no requirement in the broadest aspects of the disclosure that the tines are arranged circumferentially around the axis of the shaft. In other embodiments the tines could be irregularly spaced. The plunger could comprise a central body that cooperates with the shaft, and the tines could be connected to the central body via one or more intermediate members, as long as they translate with the central body as the shaft rotates. However, it should be noted that the optimum operation is achieved by maximizing the symmetry of the tines around the central body.

What is claimed is:

1. An apparatus for dispensing a solid oral dosage form, comprising:
one or more channels, each configured to store a plurality of units of the solid oral dosage form and having an outlet for dispensing the units therefrom;
a shaft rotatable about an axis;
a nut located on the shaft and configured to translate along the axis upon rotation of the shaft;
one or more tines configured to translate with the nut, wherein each of the one or more tines extend into a respective one of the channels and are configured to push the units of the solid oral dosage form along the length of the respective channel to the outlet, such that rotation of the shaft about the axis in use causes the units of the solid oral dosage form to be dispensed from the outlets of the channel(s) due to the translation of the one or more tines within the respective channel.

2. The apparatus as claimed in claim 1, wherein the solid oral dosage form comprises pellets and/or microtablets and/or minitablets.

3. The apparatus as claimed in claim 1, wherein the units of the solid oral dosage form have a largest dimension (e.g., width or diameter) between about 0.5 mm and about 5 mm.

4. The apparatus as claimed in claim 1, wherein the one or more tines are configured to translate along the axis a predetermined amount upon rotation of the shaft, the predetermined amount corresponding to a dimension of the units of the solid oral dosage form.

5. The apparatus as claimed in claim 1, wherein the apparatus is configured to dispense units of the solid oral dosage form one-by-one.

6. The apparatus as claimed in claim 1, wherein the apparatus is configured to provide a dose comprising a specific number of units of the oral dosage form.

7. The apparatus as claimed in claim 1, wherein the device is a hand-held and/or portable device.

8. The apparatus as claimed in claim 1, further comprising a plurality of tines, each comprising a surface that is configured to contact and push units of the solid oral dosage form along the length of the respective channel to the outlet, wherein the contact surface of a first of the plurality of tines is located at a different axial position than the contact surface of a second of the plurality of tines.

9. The apparatus as claimed in claim 8, wherein the plurality of tines comprises a first group of tines and second, different group of tines, wherein the contact surfaces of the first group of tines are all located at substantially the same first axial position and the contact surfaces of the second group of tines are located at substantially the same second axial position, wherein the first and second axial positions are different.

10. The apparatus as claimed in claim 9, wherein the contact surfaces of the first and second groups of tines are configured so that a predetermined number of units of the solid oral dosage form are dispensed at substantially the same time by the first and second groups of tines.

11. The apparatus as claimed in claim 8, wherein the tines are spaced circumferentially around a perimeter of the nut, and the contact surface of each of the plurality of tines varies depending on the circumferential position of the respective tine.

12. The apparatus as claimed in claim 11, wherein the contact surface of each of the plurality of tines varies progressively from one tine to the next in a circumferential direction.

13. The apparatus as claimed in claim 11, wherein the contact surfaces are configured such that the plurality of tines dispense units of the solid oral dosage form sequentially.

14. The apparatus as claimed in claim 1, further comprising a plurality of units of the solid oral dosage form within the channel(s), wherein a diameter of the channel(s) is sufficient for the solid oral dosage form to move within the channel(s) without a frictional contact with any surface of the channel(s).

15. The apparatus as claimed in claim 14, wherein a diameter of the channel(s) is greater than a diameter of the solid oral dosage form.

16. The apparatus as claimed in claim 15, wherein the diameter of the channel(s) is at least about 1.00 to 1.10 times a diameter of the solid oral dosage form.

17. A device comprises an apparatus as claimed in claim 1, and further comprising a control unit configured to operate the apparatus by rotating the shaft.

18. The device as claimed in claim 17, further comprising a collection region configured to receive and contain units of the solid oral dosage form that have been dispensed from the apparatus.

19. The device as claimed in claim 18, further comprising a detachable cap, wherein the collection region forms part of the detachable cap, such that the solid oral dosage form dispensed from the apparatus can be received within the cap and subsequently dispensed from the cap.

20. The device as claimed in claim 17, further comprising a cartridge that is detachable from the control unit, wherein the cartridge comprises the plurality of channels, the shaft, the nut and the one or more tines.

21. The device as claimed in claim 20, wherein the control unit and the cartridge cooperate via one or more connection mechanisms, such that rotation of a first part on the control unit causes a corresponding rotation of the shaft so as to cause the units of the solid oral dosage form to be dispensed from the outlets of the channel(s).

22. The device as claimed in claim 17, further comprising a device configured to prevent the solid oral dosage form from falling out of the channels unintentionally or when the shaft is not being rotated.

23. The device as claimed in claim 22, wherein the device configured to prevent the solid oral dosage form from falling out of the channels comprises a movable blocking member or component configured in a first position to block an exit of the solid oral dosage form from each of the channels, and in a second, different position to allow the solid oral dosage form to exit the channels.

24. The device as claimed in claim 22, wherein the blocking member or component is configured such that in a resting position, and/or when the shaft is not being rotated, the blocking member or component occupies its first position.

25. A method of operating a device or apparatus as claimed in any preceding claim, the method comprising:
storing a plurality of units of the solid oral dosage form within the channel(s); and
rotating the shaft about its axis so as to cause translation of the one or more tines and the units of the solid oral dosage form to be dispensed from the outlets of the channel(s).
